(19) United States
(12) Patent Application Publication
(10) Pub. No.: US 2013/0169001 A1
(43) Pub. Date: Jul. 4, 2013

(54) Aircraft vehicle combination

(71) Applicant: Galen Eugene Calvert, Missoula, MT (US)

(72) Inventor: Galen Eugene Calvert, Missoula, MT (US)

(21) Appl. No.: 13/374,541

(22) Filed: Jan. 3, 2012

(51) Int. Cl. B62D 35/00

(52) U.S. Cl. 296/181.5

(57) ABSTRACT

Means and methods for combining aerodynamic technology with automotive technology to produce maximum efficiency of land vehicle movement in high speed land travel by instantaneous articulation of vehicle components to as near as possible zero degrees heading into prevailing winds, instantaneous sensing of changes of efficiency and adjustments of component relative direction, laminar flow and inner vehicle pressures along with means for stabilizing the vehicle in all three aerodynamic axes.

### BACKGROUND

### Prior Art

The following is prior art that presently appears relevant:

U.S. Patents

| Patent Number | Issue Date | Patentee |
|---|---|---|
| 3,606,214 | 1971 Sep. 20 | Calvert |
| 3,952,971 | 1976 Apr. 27 | Whitcomb |
| 3,971,535 | 1976 Jul. 27 | Jones |
| 4,913,378 | 1990 Apr. 3 | Calvert |
| 7,900,876 | 2001 Mar. 8 | Eberhardt |
| 6,886,778 | 2005 May 3 | McLean |
| 6,905,092 | 2005 Jun. 14 | Somers |
| 7,357,358 | 2008 Apr. 15 | Lacy |
| 7,475,854 | 2009 Jan. 13 | Lacy |
| 7,744,040 | 2010 Jun. 29 | Lacy |

### Non Patent Literature Document

Calvert, Galen E., FEAR DYING? FEAR FLYING! Published Feb. 8, 1986

### BRIEF SUMMARY OF THE INVENTION

Means and methods for combining the following described aerodynamic technology, particularly wingtips, wings and components and appurtenances thereof, to wheeled land traveling vehicles and the body and chassis components thereof.

These above said wingtips to extend to varying heights from two to several feet above the attached body of the vehicle and may be multi-planar.

Articulated, according to the cited teaching of Patentee Calvert, the hinging and/or otherwise fastening together all the above said aerodynamic and vehicle components as means for a dramatic increased speed, safety and efficiency of land vehicle high speed travel.

Incorporating the cited teaching of Patentee Whitcomb regarding aerodynamic subsonic airflow enables the improved efficiencies afforded subsonic airflows over land vehicles by a dramatic reduction of their aerodynamic drag.

Incorporating the cited teaching of Patentee Jones, enabling much improved volumetric capacity of the above said vehicles while being almost hermetically sealed for purposed of aerodynamic efficiency.

Augmenting and or replacing land vehicular heading controls by use of aerodynamic leading edge and wingtip and wingtip enhancing components such as but not limited to the action of ailerons, rudders, flaps, slats, feathers and the relative location and interactions thereof, according to the teachings of the cited Boeing Engineers.

Using aerodynamic leverage action according to the drawings of the second cited Calvert patent, to maintain vertical stability keeping the speeding vehicles from lifting off the road surface, heading control and to further improve the vehicle anti-slipping and leveling capability.

Incorporating passenger carrying flying-wing technology of above said Jones Patent to materially improve passenger and freight carrying capacity of land vehicles.

Positioning the above said wingtips, components and appurtenances thereof to establish and maintain the most efficient laminar airflow over themselves and the said vehicles.

Augmenting and or replacing land vehicle heading controls when combined vehicles are at airplane like speeds, by use of above said leading edge and wingtip enhancing components as but not limited to the action of ailerons, rudders, flaps, slats, feathers and the relative locations and interaction thereof according to the teaching of the cited Boeing Engineers.

Providing the above said chassis component with both tandem and dual wheel combinations according to the latest aerospace engineering space vehicle wheel designs.

External and internal split-slats positioned in leading edges of major vehicle components to provide aerodynamic braking action and/or positive internal air pressure to air egress ports for best possible laminar flow around vehicle components.

### BRIEF DESCRIPTION OF THE SEVERAL VIEWS OF THE DRAWINGS

FIG. 1 is a top plan view of a preferred embodiment of the aircraft vehicle combination of the subject invention.

FIG. 2 is a side elevational view of the preferred embodiment shown in FIG. 1.

### SPECIFICATION

This invention is of a new use of the prior art, related to aircraft, partly established by those persons and inventions cited on page one of this application and the thousands of inventions and prior writings of worth associated with wheeled land vehicular development.

This new use of several aerodynamic components combined with land traveling, wheeled vehicles will be according to the teachings of three or more of the above cited patentees.

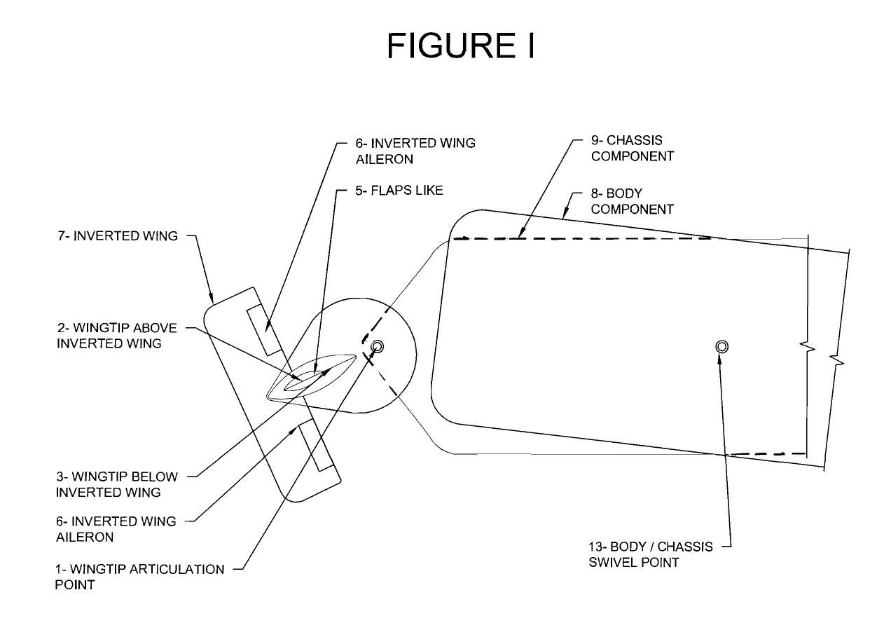

The purpose of the first of the many embodiments of the invention is to enable the wing-like components of the vehicles to articulate by means of the teachings of the first cited Calvert patent. According to the teachings of the cited Whitcomb patent regarding subsonic air flow, the new use of airfoils as wing-like components will enable the application of the teachings of the cited Boeing Engineers, regarding wingtips, leading edges, flap-like, slat-like, aileron-like, and feather-like location, warping and interaction with each other and the other components of the combined vehicle. This enabling is of all the cited patentees for railroad engine-like and railcar-like applications as well as vehicular automotive applications. (See Drawing I FIGS. 1, 2 and 3)

The teaching of the cited patent of Whitcomb's former associate, Jones, enables the much improved volumetric capacity of wheeled land vehicles as well as their habitability while being almost hermitically sealed for purposes of aerodynamic efficiency.

As used herein hermetic means almost because for the purpose of most efficient aerodynamic air flow the essential joints of doors and other openings for ingress and egress may be detail designed to emit or absorb airflow. This is true of the non-passenger carrying chassis components of the vehicles as well as the passenger carrying body components of the vehicle/s. (See Drawing I FIGS. 4 and 5)

While the first embodiment of this invention relates to single vehicles, other embodiments include fifth-wheel, automobile and/or truck pulled trailers and three or more coupled together power units pulling non-powered units. Best used for long distance travel of people and/or freight, additional overall efficiencies will be derived by travel between 75 miles per hour to over 200 miles per hour.

In practice, the wingtip components of this Aircraft Vehicle Combination will articulate on a computer controlled microsecond basis to produce the least possible drag on themselves and also to enable the least possible drag on the total mass of the vehicles.

To do this, unless “locked-out” by each combined vehicle operator, for safe operations related to traffic, road conditions, dangerously gusting winds and/or insufficient speed, the first purpose of the articulation of the wingtip component is to accomplish as small as possible variance away from zero (0) degrees heading of the vehicle body into the relative wind. Body and chassis terminology goes back to how most road vehicles were built from their beginnings until just after WWII, unibody construction became the norm. Obviously, as taught by prior art related to wheeled vehicles, the chassis components must follow the desired heading of travel of the combined vehicle.

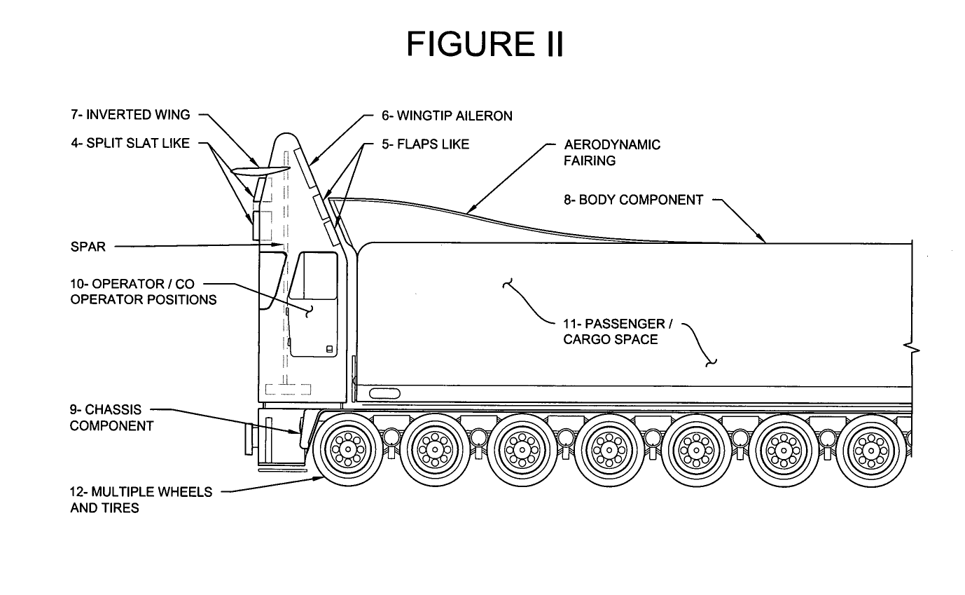

The above said almost continuous movements are controlled by the vehicle operator/s and/or conventional automatic-pilot equipment. All these articulations are dampened for all such reasons as safety, operator and passenger comfort, and general smoothness of mechanical operation. Such dampening is also known to the prior art related to land vehicles, for example, vehicle shock absorbers. (See Drawing II FIGS. 1 and 2)

Efficient headings into prevailing winds are impossible for land vehicles except when the vehicle travel happens to parallel its headwind. The above described articulation of the components of this invention permits the most efficient possible headings into prevailing winds of these terrain operating wheeled vehicles.

Another object of this Aircraft Vehicle Combination is to use its most important aerodynamic asset, the leading edge of the wing-like component of the vehicles to so order the high airflow over, adjacent to and/or trailing itself to get the most efficient possible laminar airflow movement over the vehicles. Again, this will be by the employment of the teachings of the cited Boeing Engineers, coupled with computerized sensing of drag related to the minute changes of airflow over all the components of the land vehicles.

The most important object of the Aircraft Vehicle Combination concept is for its impact on world commerce, particularly in developing nations lacking adequate long distance land travel facilities. The most efficient means of employment of this concept will enable long distance land travel to over 200 miles per hour.

Road grades of twice or more of those used by railroad trains may be used by Aircraft Vehicle Combinations, thus shortening by half or more the distance traveled in hilly and mountainous regions. Additionally, as supplements to both ordinary road and railroad travel, with aerodynamic heading and stabilization control, safe down grade travel may be a multiple of vehicle current downgrade travel.

The two granted claims of the second cited Calvert patent enables augmented and/or complete control of these vehicles depending on their airspeed. As in aircraft, in more airspeed is the more aerodynamic efficiency and control. This Calvert patent also teaches the extreme advantage of using aerodynamic leverage in controlling objects traveling at speed.

The wing shaped body components are necessarily of greater height than the rest of the body and chassis components of the vehicle. The many possible detail designs may be of these first articulating components being from a foot or two to twice and more as high as the rest of the vehicles, area government road restrictions permitting.

These components may be monoplane or biplane and may be of differing heights themselves. If monoplane, they move by articulating from their static position at the centerline of the vehicle's chassis component to the right or left of its centerline. If biplane these wing shaped bodies also move by articulation to the left and right but also a bit forward and back.

These applications of aerodynamic prior art also improve the passenger and/or weight carrying capacity of the vehicles. Additionally, the application of aerodynamic leverage, at detail designed usage speeds for between 75 to over 200 miles per hour, will dramatically improve horizontal stability control. This will materially reduce land vehicle loss of control and roll-over accidents when because of high speeds there is an un-stabilizing upward movement of the vehicle center of gravity.

Because of the previously unheard of speeds contemplated for Aircraft Vehicle Combinations, a myriad of detail designs and patents thereof may result. This inventive concept includes specific claims related to the chassis component and the location, number of wheels and tires and their design parameters.

Multiple wheels and tire tread design, in both tandem and/or dual configurations improve these land vehicle's safe operation from maximum vehicle speed to stand still in case of failure of one or more tires or wheels, as well as completion of efficient laminar airflow over the entire vehicle. A new use of many recent improvements by computer monitoring of land vehicle dynamic operating components is also claimed.

1-12. (canceled)

13. A land traveling wheeled vehicle comprising:
an aerodynamically configured wheeled chassis;
an aerodynamically and a near hermetically sealed body attached to the wheeled chassis; and
at least one wing articulatedly connected to the wheeled chassis;
wherein the land traveling wheeled vehicle is capable of traveling at high speeds safely and efficiently.

14. The wheeled vehicle of claim 1, wherein said at least one wing comprises an operator compartment.

15. The wheeled vehicle of claim 1, wherein said body pivots relative to said wheeled chassis.

16. The wheeled vehicle of claim 1, wherein at least one of said at least one wing extends above said body at least two feet.

17. The wheeled vehicle of claim 1, wherein at least one of said at least one wing comprises a structure selected from the group consisting of: ailerons, rudders, flaps, slats, and feathers.

18. The wheeled vehicle of claim 1, further comprising an inverted wing disposed on said at least one wing.

19. The wheeled vehicle of claim 18, wherein said inverted wing comprises a structure selected from the group consisting of: ailerons, rudders, flaps, slats, and feathers.

20. The wheeled vehicle of claim 1, wherein said wheeled chassis comprises dual wheels.

21. The wheeled vehicle of claim 1, wherein said wheeled chassis comprises tandem wheels.

22. The wheeled vehicle of claim 1, further comprising split-slats on a leading edge of a component of said wheeled vehicle.

23. A land traveling wheeled vehicle comprising:
an aerodynamically configured wheeled chassis;
an aerodynamically and a near hermetically sealed body pivotally attached to the wheeled chassis; and
at least one wing articulatedly comprising an operator compartment connected to the wheeled chassis;
wherein the land traveling wheeled vehicle is capable of traveling at high speeds safely and efficiently.

24. The wheeled vehicle of claim 23, wherein at least one of said at least one wing extends above said body at least two feet.

25. The wheeled vehicle of claim 23, wherein at least one of said at least one wing comprises a structure selected from the group consisting of: ailerons, rudders, flaps, slats, and feathers.

26. The wheeled vehicle of claim 23, further comprising an inverted wing disposed on said at least one wing.

27. The wheeled vehicle of claim 26, wherein said inverted wing comprises a structure selected from the group consisting of: ailerons, rudders, flaps, slats, and feathers.

28. The wheeled vehicle of claim 23, wherein said wheeled chassis comprises dual wheels.

29. The wheeled vehicle of claim 23, wherein said wheeled chassis comprises tandem wheels.

30. The wheeled vehicle of claim 23, further comprising split-slats on a leading edge of a component of said wheeled vehicle.

31. A land traveling wheeled vehicle comprising:
an aerodynamically configured wheeled chassis;
an aerodynamically and a near hermetically sealed body pivotally attached to the wheeled chassis;
at least one wing articulatedly comprising an operator compartment connected to the wheeled chassis and at least one of the at least one wings extending above the body at least two feet, at least one of the at least one wing comprising a structure selected from the group consisting of: ailerons, rudders, flaps, slats, and feathers;
an inverted wing disposed on the at least one wing, the inverted wing comprising a structure selected from the group consisting of: ailerons, rudders, flaps, slats, and feathers; and
split-slats on a leading edge of a component of said wheeled vehicle;
wherein the land traveling wheeled vehicle is capable of traveling at high speeds safely and efficiently.
